(19) United States
(12) Patent Application Publication
(10) Pub. No.: US 2024/0257237 A1
(43) Pub. Date: Aug. 1, 2024

(54) BLOCKCHAIN-BASED FIAT CURRENCY CONVERSIONS AND TRANSFERS

(71) Applicant: NCR Corporation, Atlanta, GA (US)

(72) Inventor: Bryan Walser Nonni, Atlanta, GA (US)

(21) Appl. No.: 18/102,908

(22) Filed: Jan. 30, 2023

(51) Int. Cl. G06Q 40/04; G06Q 20/36

(52) U.S. Cl. CPC G06Q 40/04; G06Q 20/3678; G06Q 2220/00

(57) ABSTRACT

Instances of a cloud-based service are provided. A first instance resides in a sender's country associated with a sender of a remittance; a second instance resides in a recipient's country associated with a recipient of the remittance. The sender provides the first instance a financial account of the recipient in the recipient's country. The sender sends an amount of cryptocurrency from a sender's wallet to a custodial wallet of the sender that is maintained by the first instance in a pooled wallet. While the transfer is pending on a blockchain (BC), the pooled wallet is used by the second instance to locate an exchange with a lowest conversion rate for redeeming the amount into a fiat current associated with the recipient's country. The amount is redeemed through the exchange and while the exchange is pending the second instance transfers the fiat currency directly to the recipient's financial account.

### BACKGROUND

Fiat currency conversions and transfers are often fraught with expensive fees, are cumbersome to perform, and are difficult for many consumers to complete. Governmental regulations of the countries involved in the transfers must also be followed. Not only does a consumer pay to convert the fiat currency based on current market rates between the fiat currencies, but the financial institution involved tacks on additional fees. Largely because of the lucrative fees charged, the financial institutions have had little incentive to change their existing workflows and technologies.

Fiat conversions and transfers are common remittances performed by migrants who work in a different country from where they previously resided. These workers frequently send funds back to their loved ones, and the recipients rely on the transferred funds to survive in their native countries. Often, a worker performs an inter-country fiat currency remittance on a weekly basis or each time the worker receives a paycheck. These consumers have unfortunately become accustomed to the fees although they are likely vulnerable and impoverished.

Yet, even well-off multinational corporations experience the process and fees on a daily basis. These corporations are frequently remitting funds between countries associated with their subsidiaries for a variety of reasons, such as cash flow, investments, governmental regulations, and taxes. Thus, existing workflows and fees associated with fiat currency conversions and transfers are inefficient, can be time consuming, and are difficult to perform, particularly for inexperienced consumers.

### SUMMARY

In various embodiments, methods and a system for blockchain (BC)-based fiat currency conversions and transfers are presented. According to an embodiment, a method for a BC-based fiat currency conversion and transfer is provided. Multiple instances of a cloud-based remittance service is provided. A first instance resides and operates within a sender's country while the second instance resides and operates within a recipient's country. A sender defined conditions for a remittance to a recipient through the first instance by at least providing a financial account associated with the recipient within the recipient's country. The sender transfers over a BC an amount of cryptocurrency from a sender's wallet to a custodial wallet maintained by the first instance in a pooled wallet. While the transfer is pending on the BC, the first instance credits the amount of cryptocurrency in the custodial wallet maintained for the sender. The second instance identifies and exchange with the lowest conversion rates for redeeming the amount of cryptocurrency into a fiat currency associated with the recipient's country. The second instance initiates converting the cryptocurrency amount on the BC using the pooled wallet of the instance. While the conversion is pending, the second instance uses a pooled financial account located in the recipient's country to transfer the amount from the pooled financial account of the second instance directly into the recipient's financial account in the fiat currency of the recipient's country.

### BRIEF DESCRIPTION OF THE DRAWINGS

FIG. 1 is a diagram of a system for BC-based fiat currency conversions and transfers, according to an example embodiment.

FIG. 2 is a diagram of a method for BC-based fiat currency conversion and transfer, according to an example embodiment.

FIG. 3 is a diagram of another method for BC-based fiat currency conversion and transfer, according to an example embodiment.

### DETAILED DESCRIPTION

As stated above, existing workflows and fees associated with inter-country fiat currency remittances have a variety of inefficiencies. Unfortunately, conventional Bitcoin® (BTC)-based approaches do not solve the issues because BTC transfers take typically 10 minutes to finalize over the BC. Existing, BC approaches require a sender to uses one or more cryptocurrency exchanges. The sender's in-country exchange is used by the sender to send BTC to a target-country exchange associated with the recipient. The BTC is then sold in the target country exchange for the target country's fiat currency and transferred to a financial account in the target country associated with the recipient. This arrangement can require the sender to have multiple accounts and wallets with multiple exchanges and is subject to fees by each exchange. So, not only is it more time consumer than non-BC inter-country remittances, but it can also be more expensive.

These existing inter-country fiat currency remittance issues are solved with the teachings provided herein. A sender transfers cryptocurrency from the sender's wallet to a custodial wallet held by a cloud-based service that pools cryptocurrencies of registered users in service-based wallet within a sending country associated with the sender. A user interface to the service permits the user to designate conditions associated with a sender's remittance transaction. The conditions can include a financial fiat-currency account associated with the recipient of the remittance.

The amount of cryptocurrency being transferred for the remittance is issued to the BC for transferring from the sender's wallet to the service's pooled wallet. Once a confirmation is received from the BC that the transfer is pending, the service immediately credits the sender's custodial wallet with the amount of cryptocurrency that is pending on the BC. If the cryptocurrency type associated with the sender's wallet was a stable coin such as USD coin, the service credits the custodial wallet for the sender with an equivalent amount of the stable coin in BTC using the service's pooled cryptocurrency wallet such that no on-chain (i.e. over the BC) transaction needs to be processed. If the original sender's transfer amount is in cryptocurrency other than stable coin or BTC, the service credits the custodial wallet for the sender with an equivalent amount of the BTC off-chain using the service's pooled cryptocurrency wallet.

The amount of BTC is then transferred to another pooled wallet associated with the service that is managed in the target country of the recipient by a second instance of the service. The second instance of the service, managed within the target country, sells the amount of BTC from the service's pooled wallet that is managed in the target county in the target country's fiat currency through an in-target country cryptocurrency exchange by selecting the exchange having the lowest conversion fees, this is done on-chain (i.e., over the BC). Once the BC confirms the transaction is pending, which can take just a minute or two, the second instance of the service uses a pooled financial account of the service in the target country to transfer the amount sent by the sender directly into the financial account of the recipient from the second instance of the service's financial account. The entire remittance process can be processed in substantially less elapsed time with substantially lowered fees from that which has previously been available in the industry.

As used herein, a “fiat currency” is a government backed currency, such as U.S. dollars, European Euros, Mexican Pesos, Brazilian Reals, etc. A “cryptocurrency” includes different types, such as BTC, Ethereum® (ETH), Dodgecoin® (Dodge), etc.

A “sender” is a consumer or an entity that is remitting currency outside of the sender's country to a recipient located within a recipient's country. A “recipient” is a consumer or an entity that is receiving remitted currency from a sender. A “remittance” is a transfer of currency from a sender to a recipient. The remittance can be associated with a transaction between the sender and the recipient or can be associated with a gift or a donation from the sender to the recipient.

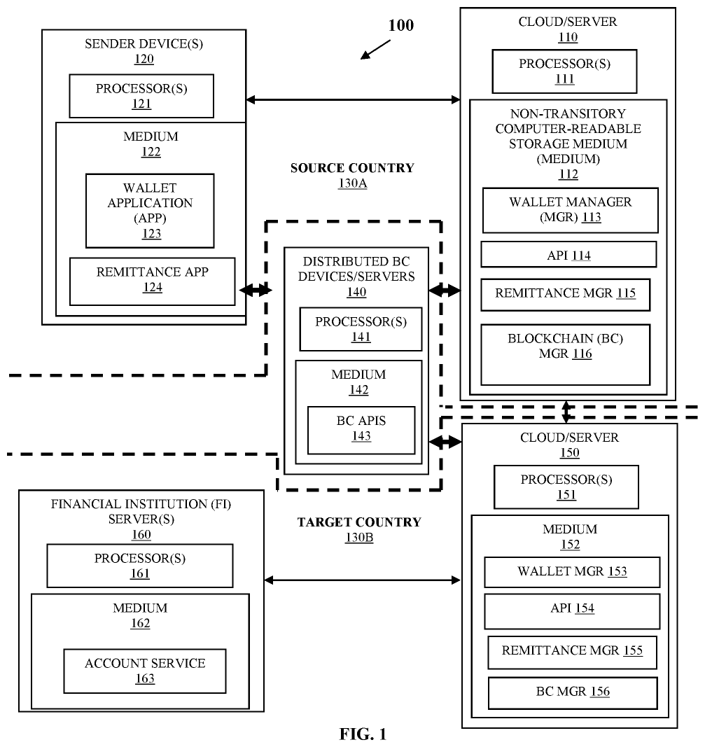

FIG. 1 is a diagram of a system 100 for BC-based fiat currency conversions and transfers, according to an example embodiment. The system 100 is shown schematically in greatly simplified form, with only those components relevant to understanding of one or more embodiments (represented herein) being illustrated. The various components are illustrated, and the arrangement of the components are presented for purposes of illustration only. It is to be noted that other arrangements with more or less components are possible without departing from near instantaneous BC-based fiat currency conversions and transfers presented herein and below.

Moreover, various components are implemented as one or more software modules, which reside in non-transitory storage and/or hardware memory as executable instructions that when executed by one or more hardware processors perform the processing discussed herein and below.

System 100 includes a first instance of a cloud/server 110 (hereinafter just “cloud 110”), sender devices 120, a BC that includes distributed BC devices 140, a second instance of a cloud 150, and financial institution servers 160. Cloud 110 includes one or more processors 111 and a non-transitory computer-readable storage medium (hereinafter just medium) 112, which includes instructions for wallet manager 113, API 114, remittance manager 115, and BC manager 116. The instructions when executed by processor 111 cause processor 111 to perform operations discussed herein and below with respect to 113-116. Similarly, cloud 150 includes one or more processors 151 and medium 152, which includes instructions for wallet manager 153, API 154, remittance manager 155, and BC manager 156. The instructions when executed by processor 151 cause processor 151 to perform operations discussed herein and below with respect to 153-156.

Each sender device 120 includes one or more processors 121 and medium 122, which includes instructions for wallet application 123 and remittance application (app) 124. The instructions when executed by processor 111 cause processor 111 to perform operations discussed herein and below with respect to 123-124.

Each financial institution (herein after just “FI”) includes one or more processors 161 and medium 162, which includes instructions for account service 163. The instructions when executed by processor 161 cause processor 161 to perform operations discussed herein and below with respect to 163.

Each distributed BC device/server 140 includes one or more processors 141 and medium 142, which includes instructions for BC APIs 143. The instructions when executed by processor 141 cause processor 141 to perform BC operations using the BC APIs 143.

Initially, senders of fiat currency obtain remittance app 124 from cloud 110. This can be obtained, downloaded, and initiated on a given sender's device 120 in any existing manner by which mobile apps or obtained such as through an app store, via a web browser, by scanning a Quick Response (QR) code, etc.

The senders may or may not have an existing wallet app 123. In cases where a given sender lacks a wallet app 123, remittance app 124 downloads a wallet app 123 during registration of a sender with remittance manager 115.

During a sender registration, a user-facing interface of remittance app 124 permits sender registration information to be collected from the sender and provided to remittance manager 115 of cloud 110. Any governmental compliance data can also be obtained during registration when required such as citizenship status for the sender in source country 130A, full legal name of sender, full social-security number (SSN) or last 4 digits of sender's SSN (which can be used to automatically verify and obtain the sender's SSN by remittance manager 116.

During registration, remittance manager 115 may ask the sender through the user interface of remittance app 124 whether the sender has an existing wallet application 123 for use with cryptocurrency and/or fiat currency. If the sender has such wallets 123, the sender provides the wallet identifiers during registration. If the sender lacks such wallets, the sender is asked whether the sender would like one to be created for the sender and the registration session is redirected to a wallet-based service for the sender to register and obtain wallet app 123. It is noted that in some embodiments presented herein and below there is no requirement that the sender have a wallet app 123 for purposes of remitting funds to a recipient of the sender located in a target country 130B.

The user interface of remittance app 124 permits a sender to initiate a remittance from source country 130A to a recipient in a target country 130B. Remittance manager 115 obtains the details regarding the remittance, such as recipient name, fiat currency amount to transfer to the recipient, recipient contact addresses or phone numbers, and a recipient financial account including routing number for the proper FI that manages and controls the recipient's account.

Next, the sender transfers the amount of funds being sent to the recipient directly to cloud 110. This can be done in a variety of manners, such as via a credit card using a fiat currency of the sender, via a bank transfer from an account of the sender in the source country 130A to an account identified by remittance manager 115 for cloud 110, and/or via wallet app 123 to cloud 110 using a wallet identifier associated with cloud 110 and provided to the sender by remittance manager 115.

When the sender is providing the funds to a remittance via cryptocurrency through wallet app 123, wallet manager 113 uses the wallet identifier of the sender to inspect the BC for the transfer. Once the BC indicates that the funds in a given cryptocurrency type was initiated for transfer from the sender's wallet to the cloud wallet maintained by cloud 110, wallet manager 113 credits a custodial wallet held for the sender by wallet manager 113 with the full amount of the funds in the cryptocurrency type associated with the wallet-to-wallet transfer from the sender to cloud 110.

Wallet manager 113 maintains a single wallet for cloud 110 and within that single wallet maintains a plurality of custodial wallets for senders managed by a ledger. Since the funds for the custodial wallets are pooled together within the single cloud wallet for cloud 110, wallet manager 113 can monitor the wallet-to-wallet transfer for completion on the BC but can near instantaneously credit the sender's custodial wallet with the funds being transferred. The credit given to the sender's custodial wallet is off-chain meaning no BC operation is needed by wallet manager 113. The type of cryptocurrency supplied by the sender with the funds is credited to the sender's custodial wallet in a current equivalent amount of BTC when the cryptocurrency type was not originally BTC. That is, if the sender provided USD or ETH with the wallet-to-wallet transfer, wallet manager 113 uses a current exchange rate for USD or ETH and BTC to credit the user's custodial wallet with an equivalent amount of BTC.

Wallet manager 113 manages the single cloud wallet by maintaining funds in a stable coin associated with source country 130A and BTC. Thus, when a non-stable and non-BTC cryptocurrency type is provided with a sender in a wallet-to-wallet transfer to cloud 110, wallet manager 113 may initiate a separate BC transfer to exchange the cryptocurrency type provided by the sender into a stable or BTC equivalent for maintaining in the single cloud wallet of cloud 110.

When the sender uses a fiat currency means to provide the funds for remittance to a desired recipient, wallet manager 113 credits the custodial wallet of the sender with an equivalent amount of BTC once the FI of the cloud 110 in the source country 130A indicates the fiat funds were transferred from a sender's financial account to the cloud's financial account, which is a matter of seconds using existing fiat currency payment networks. Wallet manager 113 then initiates a purchase transfer via the BC for the amount of the fiat currency to a stable coin for the source country 130A. This purchase transaction can be done completely outside the workflow of the sender's remittance and is only done for purposes of the wallet manager 113 maintaining liquidity for remittance transactions in the single cloud wallet. Ledgers maintained by wallet manager 113 provide the proper credits and balances for each sender shown to the sender's via the user interface of remittance app 124 in either a stable coin or BTC.

Any BC operations that are performed on-chain by wallet manager 113 are processed by BC manager 116. Optionally, a sender with a cryptocurrency wallet app 123 can independently perform BC operations on the BC via the corresponding wallet app 123.

Once a sender has provided funds for a remittance to a recipient and the custodial wallet held for the sender is credited appropriately in an equivalent amount of BTC by wallet manager 113 (which can take just a minute or less), remittance manager 115 uses API 114 to interact with second cloud instance 150. The recipient's financial account details are provided and the funds in BTC are identified that is to be redeemed for fiat currency of the target country 130B and transferred to the recipient's financial account using account service 163. Wallet manager 153 identifies the amount of BTC in the single cloud wallet and searches for a local exchange with the lowest rate to redeem the amount of BTC into an equivalent amount of the target country's fiat currency. The BC operation is initiated by BC manager 156 and as soon as it is showing as pending on the BC for completion, remittance manager 155 initiates a FI transfer between a financial account of cloud 150 in the target country 130B to the recipient's financial account using API 154. Once the transfer is completed, the fiat currency of the target country can be withdrawn and viewed by the recipient in their account with their FI in the target country 130B.

In an embodiment, each cloud instance 110 and 150 maintains its own separate pooled custodial accounts. During a remittance wallet manager 113 performs a wallet-to-wallet transfer of the sender's BTC in the single wallet of cloud 110 to a single wallet of cloud 150. Again, the transfer can be credited instantaneously by wallet manager 153 such that there is no delay in the remittance workflow because second cloud instance 150 maintains pooled custodial wallets and a target country financial account for liquidity of remittances initiated by senders of the target country 130B to other countries outside of the target country 130B.

Unlike conventional remittances, a remittance is streamlined and can be completed in minutes or seconds once initiated by a sender. There are not multiple fees levied against the sender and a lowest in-country BTC exchange is used to obtain the target country's fiat currency on behalf of the recipient. The recipient does not need to wait for the BC redemption or sale operation to complete because the second cloud instance 150 maintains a financial account with a FI in the target country 130B with a sufficient liquidity balance to transfer direct to the recipient. Thus, a remittance, which use to take days to complete, can complete in seconds or mere minutes.

System 100 permits efficient remittances utilizing multiple instances of cloud 110 and 150 that cooperate quickly and efficiently to purposes of converting funds of a remittance to BTC if needed, transferring directly to a wallet of a cloud instance 150 in the target country 130B, redeeming the BTC to the target country's fiat currency using an in-country low cost exchange, and transferring the target country's fiat currency directly to a financial account of the recipient within the target country.

In an embodiment, notifications are provided to the sender and the recipient indicating when the remittance was initiated and when the remittance is completed. The notifications can include a detailed report of fees associated with converting to BTC and the fiat currency of the target country 130B and an identifier for the local exchange used in the target country 130B.

In an embodiment, the wallet-to-wallet BTC transfer between the first cloud instance 110 and the second cloud instance 150 can be any other type of stable coin transfer and does not have to use BTC. For example, USD can be used instead of BTC.

In an embodiment, the two cloud instances 110 and 150 share a same pooled custodial wallet (assuming governmental regulations permit this for two separately operated entities or for a same entity operating in two different countries. In such a case, there is no need to perform any wallet-to-wallet transfer between the cloud instances 110 and 150, which further expedites the remittance time to completion as described herein.

In an embodiment, the first cloud instance 110 opens a one-way direct communication channel with the second cloud instance 150 during an exchange for purposes of rapidly transfer the remittance details and the corresponding BTC. The one-way channel is closed after the remittance is processed. This further expedites the remittance workflow discussed herein.

In an embodiment, senders can maintain positive balances in their custodial wallets with cloud 110 and deposit funds whenever desired or use less than all of deposited funds for any given remittance. Wallet manager 113 maintains these positive funds within the single cloud wallet in a stable coin associated with the source country 130A. Alternatively, the sender is provided an option to indicate the type of cryptocurrency for which the sender's positive balances are to be held for the sender.

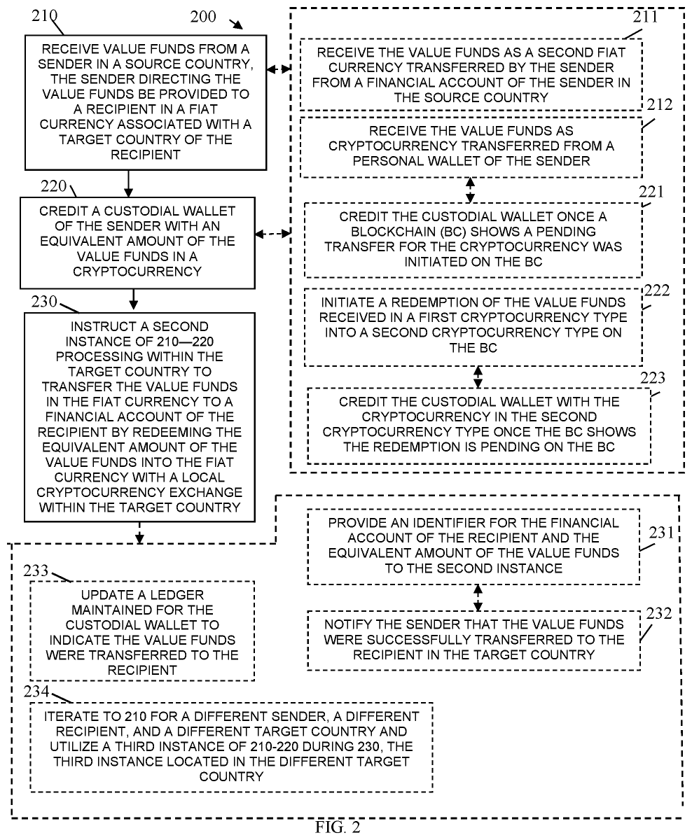

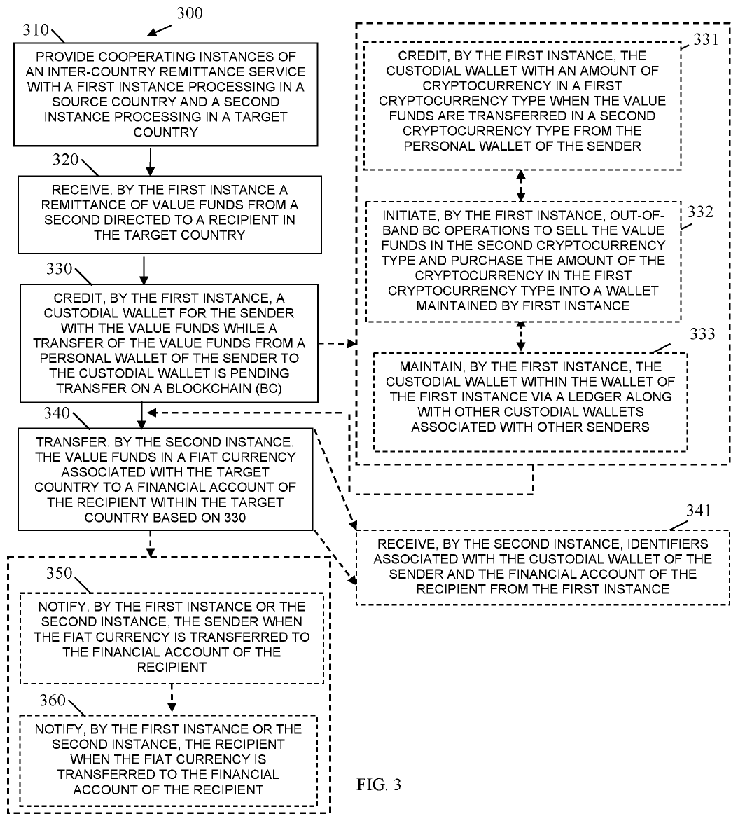

The embodiments of FIG. 1 and other embodiments are now discussed with reference to the FIGS. 2-3. FIG. 2 is a diagram of a method 200 for BC-based fiat currency conversions and transfers, according to an example embodiment. The software module(s) that implements the method 200 is referred to as a “remittance service.” The remittance service is implemented as executable instructions programmed and residing within memory and/or a non-transitory computer-readable (processor-readable) storage medium and executed by a plurality of hardware processors of a plurality of hardware computing devices. The processors of the devices that execute the remittance service are specifically configured and programmed to process the remittance service. The remittance service has access to one or more networks during its processing. The networks can be wired, wireless, or a combination of wired and wireless.

In an embodiment, the devices that execute the remittance service is cloud 110 and/or cloud 150. In an embodiment, the devices that execute the remittance service is server 110 and/or server 150.

In an embodiment, the remittance service is all or some combination of 113, 114, 115, 116, 153, 154, 155, and/or 156, discussed above with system 100.

At 210, the remittance service receives value funds from a second located in a source country. The sender is directing the value funds be provided or sent to a recipient in a fiat currency associated with a target country of the recipient.

In an embodiment, at 211, the remittance service receives the value funds as a second fiat currency transferred by the sender from a financial account of the sender within the source country. The fiat currency can be received via bank transfer from the sender's financial account to a financial account maintained by the remittance service or received as a credit card payment processed against the sender's account and deposited in the remittance service's account.

In an embodiment, at 212, the remittance service receive the value funds as cryptocurrency transferred from a personal wallet of the sender. That is, the value funds can be cryptocurrency being transferred over the BC from a personal wallet of the sender to a wallet maintained by the remittance service.

At 220, the remittance service credits a custodial wallet of the sender with an equivalent amount of the value funds in a cryptocurrency. The cryptocurrency can be a stable fiat currency coin, BTC, ETH, etc.

In an embodiment of 212 and 220, at 221, the remittance service credits the custodial wallet once the BC shows a pending transfer for the cryptocurrency was initiated on the BC. So, processing the value funds transfer does not need to wait on the actual BC transfer it is sufficient for the remittance service to see the pending transfer on the BC to credit a custodial wallet associated with the sender and maintained by the remittance service.

In an embodiment, at 222, the remittance service initiates a redemption of the value funds received in a first cryptocurrency type into a second cryptocurrency type on the BC. In an embodiment of 222 and at 223, the remittance service credits the custodial wallet with the cryptocurrency in the second cryptocurrency type once the BC shows the redemption is pending on the BC.

At 230, the remittance service instructs a second instance of the remittance service processing within the target country to transfer the value funds in the fiat currency to a financial account of the recipient. The second instance redeems the equivalent amount of the value funds into the fiat currency with a local cryptocurrency exchange operating within the target country. While the redemption is pending on the BC with the exchange, the second instance of the remittance service transfers the fiat currency from a local financial account associated with the second instance directly into the financial account of the recipient.

In an embodiment, at 231, the remittance service provides an identifier for the financial account of the recipient and the equivalent amount of the value funds to the second instance. In an embodiment of 231 and at 232, the remittance service notifies the sender that the value funds were successfully transferred to the recipient in the target country.

In an embodiment, at 233, the remittance service updates a ledger maintained for the custodial wallet to indicate the value funds were transferred to the recipient. The sender can maintain a positive balance in the custodial account maintained by the remittance service in a predefined cryptocurrency type set by the remittance service or in a cryptocurrency type preferred by the sender.

In an embodiment, at 234, the remittance service iterates to 210 for a different sender, a different recipient, and a different target country utilizing a third instance of the remittance service during 230. The third instance is locally operated within the different target country.

FIG. 3 is a diagram of another method 300 for BC-based fiat currency conversions and transfers, according to an example embodiment. The software module(s) that implements the method 300 is referred to as a “inter-country fiat currency transfer service.” The inter-country fiat currency transfer service is implemented as executable instructions programmed and residing within memory and/or a non-transitory computer-readable (processor-readable) storage medium and executed by one or more hardware processors of one or more hardware devices. The processors of the devices that execute the inter-country fiat currency transfer service are specifically configured and programmed to process the inter-country fiat currency transfer service. The inter-country fiat currency transfer service has access to one or more networks during its processing. The networks can be wired, wireless, or a combination of wired and wireless.

The inter-country fiat currency transfer service presents another and, in some ways, enhanced processing perspective of that which was described above with the method 200.

In an embodiment, cloud 110 and/or cloud 150 execute the inter-country fiat currency transfer service. In an embodiment, server 110 and/or server 150 execute the inter-country fiat currency transfer service.

In an embodiment, the inter-country fiat currency transfer service is all or some combination of 113, 114, 115, 116, 153, 154, 155, 156, and/or method 200.

At 310, the inter-country fiat currency transfer service provides cooperating instances of an inter-country remittance service. A first instance processes within a source country and a second instance processes within a target country.

At 320, the first instance receives a remittance of value funds from a sender that is being directed to a recipient in a target country. The remittance can be accompanied by a variety of details supplied by the sender through a user interface to app 124 as discussed above with system 100.

At 330, the first instance credits a custodial wallet for the sender with the value funds while a transfer of the value funds from a personal wallet of the sender to the custodial wallet is being on the BC. Thus, it is sufficient for the first instance to see that the transfer was initiated and is pending on the BC to credit the custodial wallet of the sender with the value funds.

In an embodiment, at 331, the first instance credits the custodial wallet with an amount of cryptocurrency in a first cryptocurrency type when the value funds are transferred in a second cryptocurrency type from the personal wallet of the sender. That is, the first instance maintains a first cryptocurrency type for the custodial account and converts via an exchange when the value funds are something other than the first cryptocurrency type.

In an embodiment of 331 and at 332, the inter-country fiat currency transfer service initiates out-of-band BC operations to sell the value funds in the second cryptocurrency type and purchase the amount of the cryptocurrency in the first cryptocurrency type into a wallet maintained by the first instance and/or the second instance. It is out-of-band because the first instance does not process these BC operations as part of the workflow associated with the remittance request; rather, the first instance processes these BC operations for purposes of maintaining sufficient liquidity in the wallet that is used for custodial wallets of senders. In an embodiment of 332 and at 333, the first instance maintains the custodial wallet within the wallet of the first instance via a ledger along with other custodial wallets associated with other senders.

At 340, the second instance transfers the value funds in a fiat currency associated with the target country to a financial account of the recipient within the target country based on 330. Thus, as soon as the custodial wallet for the sender is credited with the value funds, the second instance processes to transfer the target country's fiat currency on behalf of the sender.

In an embodiment, at 341, the second instance receives identifiers associated with the custodial wallet of the sender and the financial account of the recipient from the first instance. In an embodiment, when the sender sometimes or is permitted to maintain a positive custodial wallet balance, the second instance may also receive an amount that is to be transferred to the financial account of the sender in the target country's fiat currency.

In an embodiment, at 350, the first instance of the second instance notify the sender when the fiat currency is transferred to the financial account of the recipient. In an embodiment, at 360, the first instance or the second instance can also notify the recipient when the fiat currency is transferred to the financial account of the recipient.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving value funds from a sender in a source country, wherein the sender is directing the value funds be provided to a recipient in a fiat currency associated with a target country of the recipient;
crediting a custodial wallet of the sender with an equivalent amount of the value funds in a cryptocurrency;
instructing a second instance of the method processing within the target country to transfer the value funds in the fiat currency to a financial account of the recipient by redeeming the equivalent of the value funds into the fiat currency with a local cryptocurrency exchange within the target country.

2. The method of claim 1, wherein receiving further includes receiving the value funds as a second fiat currency transferred by the sender from a financial account of the sender in a source country.

3. The method of claim 1, wherein receiving further includes receiving the value funds as cryptocurrency transferred from a personal wallet of the sender.

4. The method of claim 3, wherein crediting further includes crediting the custodial wallet once a blockchain shows a pending transfer for the cryptocurrency was initiated on the blockchain.

5. The method of claim 1, wherein crediting further includes initiating a redemption of the value funds received in a first cryptocurrency type into a second cryptocurrency type on a blockchain.

6. The method of claim 5, wherein initiating further includes crediting the custodial wallet with the cryptocurrency in the second cryptocurrency type once the blockchain shows the redemption is pending on the blockchain.

7. The method of claim 1, wherein instructing further includes providing an identifier for the financial account of the recipient and the equivalent amount of the value funds to the second instance.

8. The method of claim 1 further comprising, receiving notification from the second instance that the equivalent amount of the value funds were redeemed and transferred to the financial account of the recipient in the target country.

9. The method of claim 8 further comprising, notifying the sender that the value funds were successfully transferred to the recipient in the target country.

10. The method of claim 1 further comprising, updating a ledger maintained for the custodial wallet to indicate the value funds were transferred to the recipient.

11. The method of claim 1 further comprising, iterating to the receiving for a different sender, a different recipient, and a different target country and utilizing a third instance of the method during the instructing located in the different target country.

12. A method, comprising:
providing cooperating instances of an inter-country remittance service with a first instance processing in a source country and a second instance processing in a target country;
receiving, by the first instance, a remittance of value funds from a sender directed to a recipient in the target country;
crediting, by the first instance, a custodial wallet for the sender with the value funds while a transfer of the value funds from a personal wallet of the sender to the custodial wallet is pending transfer on a blockchain; and
transferring, by the second instance, the value funds in a fiat currency associated with the target country to a financial account of the recipient within the target country based on the crediting.

13. The method of claim 12 further comprising:
notifying, by the first instance or the second instance, the sender when the fiat currency is transferred to the financial account of the recipient.

14. The method of claim 13 further comprising:
notifying, by the first instance or the second instance, the recipient when the fiat currency is transferred to the financial account of the recipient.

15. The method of claim 12, wherein crediting further includes crediting, by the first instance, the custodial wallet with an amount of cryptocurrency in a first cryptocurrency type when the value funds are transferred in a second cryptocurrency type from the personal wallet of the sender.

16. The method of claim 15, wherein crediting further includes, initiating, by the first instance, out-of-band blockchain operations to sell the value funds in the second cryptocurrency type and purchase the amount of the cryptocurrency in the first cryptocurrency type into a wallet maintained by the first instance.

17. The method of claim 16, wherein maintaining, by the first instance, the custodial wallet within the wallet of the first instance via a ledger along with other custodial wallets associated with other senders.

18. The method of claim 12, wherein transferring further includes receiving, by the second instance, identifiers associated with the custodial wallet of the sender and the financial account of the recipient from the first instance.

19. A system comprising:
a cloud comprising a plurality of servers;
each server comprising at least one processor and a non-transitory computer-readable storage medium;
each non-transitory computer-readable storage medium comprising executable instructions;
the executable instructions when provided to or obtained by the corresponding processor from the corresponding non-transitory computer-readable storage medium cause the corresponding processor to perform operations, comprising:
processing a first instance of the executable instructions on a first server within a source country;
processing a second instance of the executable instructions on a second server within a target country;
receiving, by the first instance, a remittance request with value funds from a sender, the value funds being directed from the sender to a financial account of a recipient within the target country;
crediting, by the first instance, an amount of cryptocurrency in a first cryptocurrency type to a custodial wallet of the sender while the value funds are pending transfer on a blockchain from a personal wallet of the sender to a wallet maintained by the first instance and the second instance;
providing, by the first instance, identifiers for the custodial wallet and the financial account of the recipient to the second instance;
locating, by the second instance, a cryptocurrency exchange locally associated with the target country that has a lowest conversion rate for converting the first cryptocurrency type to a fiat currency of the target country;
initiating, by the second instance, a sale of the amount of the first cryptocurrency type into an equivalent amount of the fiat currency with the cryptocurrency exchange over the blockchain; and
transferring, by the second instance, the equivalent amount of fiat currency from a second financial account associated with the second instance to the financial account of the recipient while the sale is pending on the blockchain.

20. The system of claim 19, wherein the executable instructions when provided to or obtained by the corresponding processor from the corresponding non-transitory computer-readable storage medium further cause the corresponding processor to perform additional operations, comprising:
maintaining, by the first instance and the second instance, ledgers with respect to the custodial wallet of the sender and other custodial wallets associated with other senders and other remittance requests.
